(19) United States
(12) Patent Application Publication
(10) Pub. No.: US 2008/0256629 A1
(43) Pub. Date: Oct. 16, 2008

(54) Management Apparatus, System, and Method for Protecting a Memory Storage Card

(75) Inventors: Shih-Yao Lo, Pingjhen City (TW); Chi-Lung Wang, Hsinchu City (TW)

Correspondence Address: GROSSMAN, TUCKER, PERREAULT & PFLEGER, PLLC, 55 SOUTH COMMERICAL STREET, MANCHESTER, NH, 03101, US

(73) Assignee: SILICON MOTION, INC., Jhubei City (TW)

(21) Appl. No.: 12/040,998

(22) Filed: Mar. 3, 2008

Related U.S. Application Data
(60) Provisional application No. 60/911,716, filed on Apr. 13, 2007.

(51) Int. Cl. H04L 9/32

(52) U.S. Cl. 726/21

(57) ABSTRACT

A management apparatus, system, and method for protecting a memory storage card are provided. The management apparatus comprises an access unit and a check unit. The access unit is configured to read a first security message, and a second security message of the memory storage card. The check unit is configured to check the first and second security messages to generate a check result. The management apparatus makes the memory storage card available according to the check result and efficiently prevents the memory storage card from theft.

This application claims the benefit of priority based on U.S. Ser. No. 60/911,716 filed on Apr. 13, 2007, the disclosures of which the contents are incorporated herein by reference in their entirety.

### CROSS-REFERENCES TO RELATED APPLICATIONS

Not applicable.

### BACKGROUND OF THE INVENTION

1. Field of the Invention

The present invention relates to a management apparatus, a management system, and a method for protecting a memory storage card.

2. Descriptions of the Related Art

A memory storage card is a storage medium used to store data such as text, MP3, images, etc. Memory storage cards have a number of advantages over hard disks; they are much smaller and lighter, very portable, silent and can be immediately accessed. Furthermore, with increasing memory storage card capacities, the cards can store large files such as videos. Thus, memory storage cards are often applied in digital cameras, mobile phone or other portable apparatuses.

Because memory storage cards have become very versatile in size and in storage capacity, they have become easy targets for theft. To prevent the memory storage cards from being stolen, the memory storage card is usually protected with a scanning barcode that is widely used by retailers. However, those “barcodes” can be easily removed, and is thus, not a good deterrence from theft.

According to the aforementioned descriptions, it is not reliable to use barcode to prevent the memory storage card from being stolen. In this aspect, how to efficiently prevent the memory storage card from being stolen is still a subjective for the industry to endeavor.

### SUMMARY OF THE INVENTION

One objective of present invention is to provide a management apparatus for protecting a memory storage card. The management apparatus checks the security messages of the memory storage card and a manager card to activate the memory storage card. The user can then legally use the memory storage card. Hence, the present invention can protect the memory storage card. To achieve the aforementioned purpose, the management apparatus disclosed by the present comprises an access unit and a check unit. The access unit is configured to read a first security message, and to read a second security message of the memory storage card. The check unit is configured to check the first and second security messages to generate a check result. The management apparatus then activates the memory storage card according to the check result.

The management apparatus can be included in a management system for achieving the same objective. The management system further comprises the memory storage card and the manager card.

Yet a further objective of this invention is to provide a method for managing a memory storage card used in a management system. The method makes the memory storage card available according to the security messages of the memory storage card and the manager card. After that, the user can legally use the memory storage card. Hence, the present invention can protect the memory storage card. To achieve the aforementioned purposes, the method comprises the following steps: reading a first security message; reading a second security message; and checking the first security message and the second security message to generate a check result. Finally, the method makes the memory storage card available according to the check result.

Another objective of this invention is to provide a process apparatus for processing a manager card used in the aforementioned management apparatus. The process apparatus is configured to process the security message of the manager card to protect a memory storage card. To achieve the aforementioned purpose, the process apparatus comprises a storage unit and access unit. The storage unit is configured to pre-store a first security message. The access unit is configured to read the first security message from the storage unit and write the first security message into the manager card.

Another objective of this invention is to provide a memory storage card used in the aforementioned management apparatus. The memory storage card can be protected by the aforementioned management apparatus. The memory storage card comprises a storage unit and a transmission interface. The storage unit is configured to store the second security message. The transmission interface is configured to provide a transmission path to access the second security message.

The detailed technology and preferred embodiments implemented for the subject invention are described in the following paragraphs accompanying the appended drawings for people skilled in this field to well appreciate the features of the claimed invention.

### BRIEF DESCRIPTION OF THE DRAWINGS

FIG. 1 shows a partial schematic diagram of the preferred management apparatus of the present invention;

FIG. 2 shows a partial schematic diagram of the preferred memory storage card of the present invention;

FIG. 3 shows a schematic diagram of the preferred management system of the present invention;

FIG. 4 shows a partial schematic diagram of the preferred process apparatus of the present invention;

FIG. 5A shows a partial flowchart of a method of the present invention for managing a memory storage card;

FIG. 5B shows a partial flowchart of a method of the present invention for managing a memory storage card; and

FIG. 6 shows a flowchart of the step 52 of the method in FIG. 5.

### DESCRIPTION OF THE PREFERRED EMBODIMENT

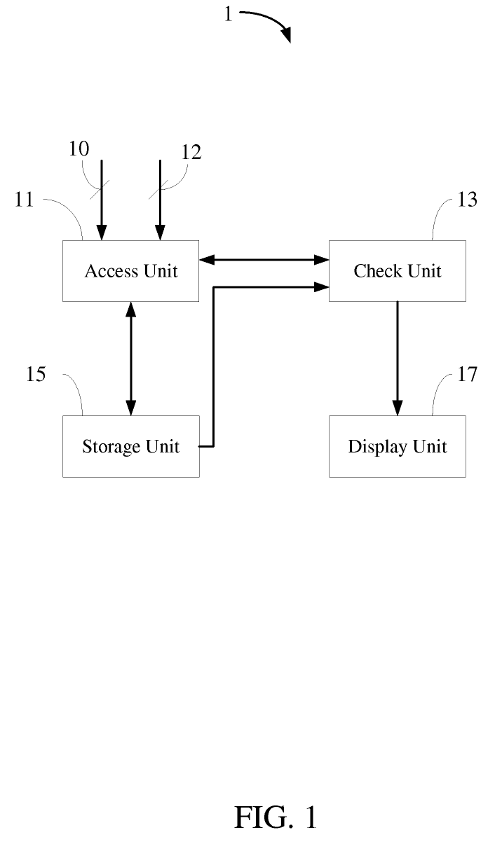

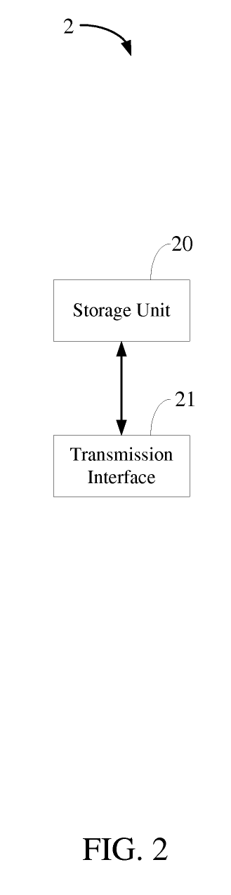

FIG. 1 shows a partial schematic diagram of a preferred management apparatus 1. The management apparatus 1 is configured to protect a memory storage card 2, and the partial schematic diagram of the memory storage card 2 is shown in FIG. 2. In this embodiment, it is assumed that the management apparatus 1 is used in retailer; thus, the memory storage card 2 has not been sold yet. While the buyer buys the memory storage card, the seller must make the memory storage card available via the management apparatus 1. Then, the buyer can legally use the memory storage card. The management apparatus 1 comprises an access unit 11, a check unit 13, a storage unit 15, and a display unit 17. The access unit 11 is configured to read a first security message 10, and a second security message 12 of the memory storage card. In FIG. 2, the memory storage card 2 comprises a storage unit 20 and a transmission interface 21. The storage unit 20 is configured to store the second security message 12. The transmission interface 21 is configured to provide a transmission path to the management apparatus 1 for accessing the second security message. The check unit 13 is configured to check the first security message 10 and the second security message 12 to generate a check result.

Particularly, the first security message 10 is pre-stored in a specific storage region of a manager card which is usually held by the seller. The specific region is formatted to a specific file system that is not compatible with other generally used file systems such as NTFS, FAT32, etc. The access unit 11 is thus configured to read the first security message 10 of the manager card. After the first security message 10 and the second security message 12 are read by the access unit 11, they are stored in the storage unit 15 which is a volatile memory in this embodiment for a moment. The check unit 13 is further configured to read the stored first security message and the second security message for checking. In this embodiment, the manager card can be removed after the first security message 10 is stored in the storage unit 15.

In this embodiment, the memory storage card has two different pre-defined types: locked or unlocked. The users can not access the data stored in locked memory card but access the one stored in unlocked card by using PC through card reader. The executive can lock the unlocked memory card and unlock the locked memory card by using manager card. For the locked memory card, the first security message 10 comprises a verification code and corresponding serial number set and the second security message 12 comprises a verification code and corresponding serial number, wherein the verification code of the first security message 10 is configured to unlock the memory storage card. The check unit 13 checks whether the serial number set comprises the serial number of the second security message to generate a serial number check result, then checks the verification codes of the first security message 10 and the second security message 12 according to the serial number check result to generate the check result as described above. In this embodiment, the serial number set of the first security message 10 represents a serial number range and the serial number of the second security message 12 is a specific serial number corresponding to the specific memory storage card. If the specific serial number is within the serial number range of the first security message 10, the serial number check result is OK. If the serial number check result and verification code check result both show that the first and second security messages correspond to each other, the management apparatus is configured to unlock the memory storage card using the verification code of the first security message via the access unit 11. After that, the buyer of the memory storage card can write data into the memory storage card or read data from the memory storage card.

For the unlocked memory storage card, the first security message 10 comprises a verification code and a corresponding serial number set, and the second security message 12 only comprises a serial number. The check unit 13 is configured to check whether the serial number set comprises the serial number of the second security message to generate the check result. If the check result shows that the first and second security messages correspond to each other, the management apparatus is configured to lock the memory storage card using the verification code of the first security message via the access unit 11.

In addition, the first security message 10 can be also manually inputted to the access unit 11 by an executive in the retailer. The display unit 17 is configured to display the check result to sellers. In this embodiment, the verification codes of both the first security message and the second security message may be product keys or passwords. The executive can also use the management apparatus 1 to change the first security message of the manager card via the access unit 11. That is, the first security message can be changed by using the management apparatus 1 through input apparatus (not shown) if necessary. In this embodiment, the memory storage card can be one of a security digital (SD) card, a multimedia card (MMC), a memory stick (MS) card or an xD-picture card. The aforementioned descriptions are just for examples and not to limit the present invention.

According to the aforementioned allocations, the management apparatus of the present invention can make the memory storage card available by checking the security messages. If a thief steals a memory storage card that has not been made available by the management apparatus, it cannot work and will be of no value to the thief. Thus, one purpose of the present invention is to efficiently prevent the memory storage card from being stolen.

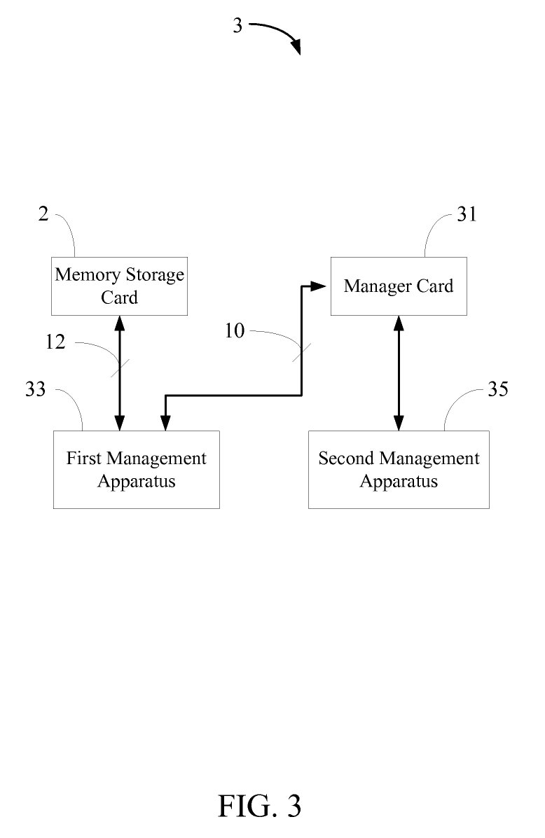

FIG. 2 and FIG. 3 illustrate another preferred embodiment of the present invention where a management system 3 is configured to protect the memory storage card 2. The management system 3 comprises the memory storage card 2, a manager card 31, a first management apparatus 33, and a second management apparatus 35. In this embodiment, it is assumed that the management system 3 is constructed in a retailer. The first management apparatus 33 is located on the counter and can be used by sellers, while the second management apparatus 35 is configured to manage the manager card 31. The memory storage card 2 has not been sold yet and the manager card 31 is being held by the sellers.

In the embodiment, the first management apparatus 33 is the same as the management apparatus 1 of the aforementioned embodiment, meanwhile the management card 2 and the manager card 31 are the same as those of the aforementioned embodiment. Therefore, the first manager apparatus 33 can process the same operations as mentioned in the previous embodiment to the management card 2 and the manager card 31.

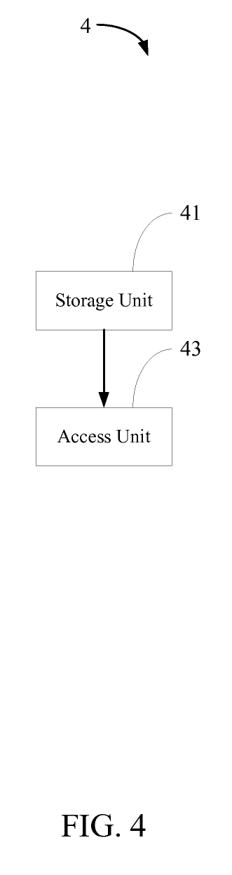

The second management apparatus 35 is mainly configured to change the first security message 10 of the manager card 31 and can either be the same management apparatus 1 as shown in FIG. 1 or a process apparatus 4 with partial schematic diagram as shown in FIG. 4. The process apparatus 4 comprises a storage unit 41 and an access unit 43. The storage unit 41 is configured to pre-store the first security message 10. The access unit 43 is configured to read the first security message 10 from the storage unit 41 and write the first security message 10 into the manager card 31. That is, the executive can change the first security message 10 of the manager card 31 via the second management apparatus 35.

According to the aforementioned allocations, the management system of the present invention makes the memory storage card available by checking the security messages. If the thief steals a memory storage card that has not been confirmed via the management system, the card will not work and thus, loses its value. As such, the present invention can efficiently prevent the memory storage card from being stolen.

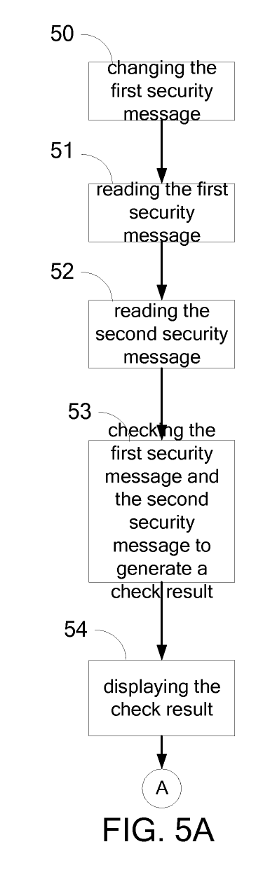

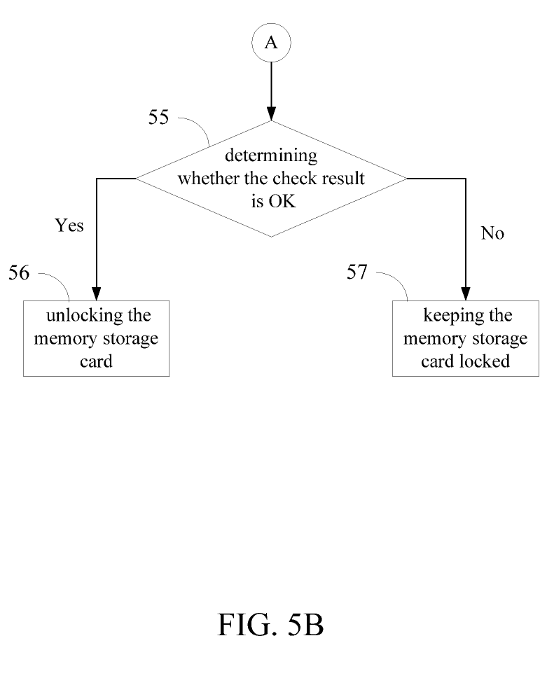

FIGS. 5A and 5B illustrates a flowchart of a method for managing a memory storage card. The method can be used in the management system 3 of the aforementioned embodiment. First, at a step 50, the first security message 10 can be changed by the second management apparatus 35. It should be noted that in this embodiment, the first security message is read from a manager card, as the manager card 31 in the management system 3. In other embodiments, step 50 may be not executed according to the actual condition. At a step 51, a first security message 10 of a manager card 31 is read. At a step 52, a second security message 12 of a memory storage card 2 is read. Then, the first security message 10 and the second security message 12 are checked to generate a check result at a step 53. The check result is displayed at a step 54. Then, the step 55 is executed to determinate whether the check result is ok. If the check result is OK, step 56 is executed to unlock the memory storage card 2. Otherwise, step 56 is executed to keep the memory storage card 2 locked.

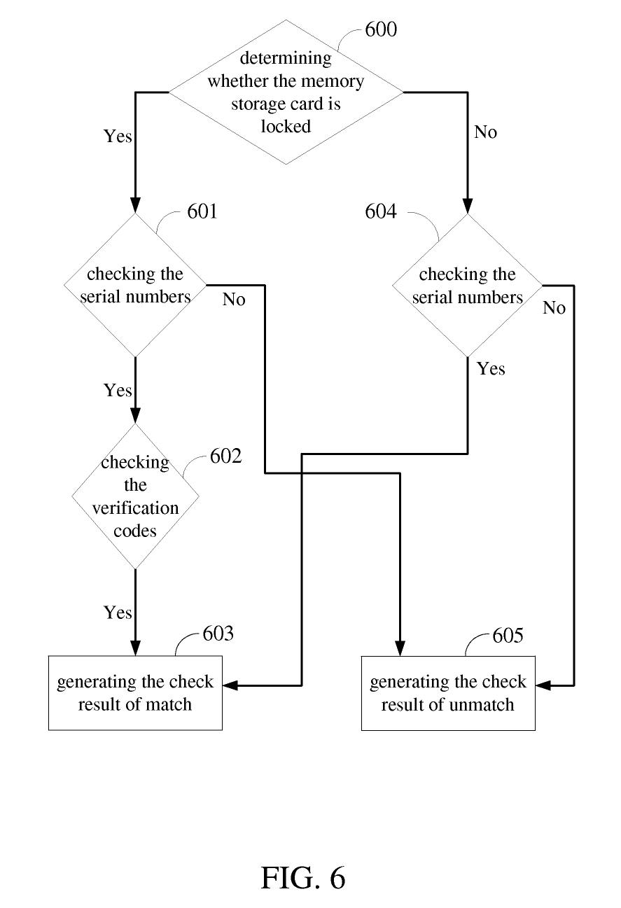

Particularly, step 52 comprises the steps as shown in FIG. 6. At a step 600, the memory storage card 2 is determined whether it is locked. If it is locked, the first security message 10 comprise a verification code and a corresponding serial number set, and the second security message 12 comprise a verification code and a corresponding serial number. Then the serial number set of the first security message 10 and the serial number of the second security message 12 are checked to generate a serial number check result at step 601. If the serial number check result indicates that the serial number set of the first security message 10 comprises the second security message 12, the verification codes of the first security message 10 and the second security message 12 are checked according to the serial number check result at a step 602. If the verification codes of the first security message 10 and the second security message 12 are checked to be matched, then, at a step 603, the check result of match is generated.

If the serial number check result indicates that the serial number set of the first security message 10 does not comprise the serial number of the second security message 12, the check result of unmatch is generated at a step 605.

If the memory storage card 2 is determined to be unlocked at the step 600, means the first security message 10 comprises a verification code and a corresponding serial number set, while the second security message 12 comprises a serial number. The serial number set of the first security message 10 and the serial number of the second security message 12 are checked at a step 604. If the serial number set of the first security message 10 does not comprise the serial number of the second security message 12, the check result of match is generated at the step 603. On the contrary, the check result of unmatch is generated at the step 605.

When the memory card 2 is originally locked, and the check result indicates match, the memory card 2 is processed to become unlocked at the step 54. On the contrary, the memory card 2 keeps locked.

When the memory card 2 is originally unlocked and the check result indicates match, the memory card 2 is processed to become locked at the step 54. On the contrary, the memory card 2 keeps unlocked.

Aside from the steps drawn in FIG. 5, this preferred embodiment can also execute all operations and functions of the management system 3 of the aforementioned embodiment. People skilled in this field can understand how this preferred embodiment executes the operations and functions based on the aforementioned embodiment. The details are not repeated here. The sequence of the flowchart in FIG. 5 is not intended to limit the present invention. People skilled in the art can modify the sequence after realizing the present invention. For example, the step 51 can be taken before the step 50.

The present invention can use the security messages of the manager card and the memory storage card to prevent the memory storage card from being stolen. When a thief steals the memory storage card at the retailers, the memory storage card has not been made available by the present invention. As such, the memory storage card can not be written or read, and thus, loses its value. Therefore, the present invention can efficiently prevent the memory storage card from being stolen.

The above disclosure is related to the detailed technical contents and inventive features thereof. People skilled in this field may proceed with a variety of modifications and replacements based on the disclosures and suggestions of the invention as described without departing from the characteristics thereof. Nevertheless, although such modifications and replacements are not fully disclosed in the above descriptions, they have substantially been covered in the following claims as appended.

What is claimed is:

1. A management apparatus for protecting a memory storage card, comprising:
an access unit being configured to read a second security message of the memory storage card and a first security message; and
a check unit being configured to check the first security message and the second security message to generate a check result.

2. The management apparatus of claim 1, wherein the first security message is stored in a manager card, the access unit is configured to read the first security message of the manager card.

3. The management apparatus of claim 1, further comprising a storage unit for storing the first and second security messages read by the access unit, wherein the check unit is configured to read the first and second security messages from the storage unit to check.

4. The management apparatus of claim 1, wherein the memory storage card is locked, the first security message comprises a verification code and a serial number set, the second security message comprises a verification code and a serial number, and the verification code of the first security message is configured to unlock the memory storage card.

5. The management apparatus of claim 4, wherein each of the verification code of the first security message and the verification code of the second security message is one of a product key and a password.

6. The management apparatus of claim 4, wherein the check unit is configured to check whether the serial number set comprises the serial number of the second security message to generate a serial number check result, and to check the verification codes of the first security message and the second security message to generate the check result according to the serial number check result; according to the check result, the management apparatus is further configured to unlock the memory storage card by the verification code of the first security message via the access unit.

7. The management apparatus of claim 1, wherein the memory storage card is unlocked, the first security message comprises a verification code and a serial number set, the second security message comprises a serial number, and the verification code of the first security message is configured to lock the memory storage card.

8. The management apparatus of claim 7, wherein the check unit is configured to check whether the serial number set comprises the serial number of the second security message to generate the check result and, according to the check result, the management apparatus is further configured to lock the memory storage card by the verification code of the first security message via the access unit.

9. The management apparatus of claim 2, wherein the manager card comprises a specific storage region storing the first security message, and the specific storage region is formatted to a specific file system.

10. The management apparatus of claim 3, wherein the storage unit is a volatile memory.

11. A management system for protecting a memory storage card, comprising:
a manager card for storing a first security message;
a memory storage card for storing a second security message; and
a first management apparatus comprising:
an access unit being configured to read the first security message and the second security message of the memory storage card; and
a check unit being configured to check the first security message and the second security message in order to generate a check result.

12. The management system of claim 11, wherein the first management apparatus further comprises a storage unit being configured to store the first and second security messages read by the access unit; the check unit is configured to read the first and second security messages from the storage unit to check.

13. The management system of claim 11, wherein the memory storage card is locked, the first security message comprises a verification code and a serial number set, the second security message comprises a verification code and a serial number, and the verification code of the first security message is configured to unlock the memory storage card.

14. The management system of claim 13, wherein the check unit of the first management apparatus is configured to check whether the serial number set comprises the serial number of the second security message to generate a serial number check result, and to check the verification codes of the first security message and the second security message to generate the check result according to the serial number check result; according to the check result, the first management apparatus is further configured to unlock the memory storage card by the verification code of the first security message via the access unit.

15. The management system of claim 11, wherein the memory storage card is unlocked, the first security message comprises a verification code and a serial number set, the second security message comprises a serial number, and the verification code of the first security message is configured to lock the memory storage card.

16. The management system of claim 15, wherein the check unit of the first management apparatus is configured to check whether the serial number set comprises the serial number of the second security message to generate the check result and, according to the check result, the first management apparatus is further configured to lock the memory storage card by the verification code of the first security message via the access unit.

17. The management system of claim 11, further comprising a second management apparatus, being configured to change the first security message of the manager card.

18. A method for managing a memory storage card, being applied in a management system, comprising the steps of:
reading a first security message;
reading a second security message of the memory storage card; and
checking the first security message and the second security message to generate a check result.

19. The method of claim 18, wherein the memory storage card is locked, the first security message comprises a verification code and a serial number set, the second security message comprises a verification code and a serial number, and the check step comprises the steps of:
checking whether the serial number set comprises the serial number of the second security message to generate a serial number check result; and
checking the verification codes of the first security message and the second security message to generate the check result according to the serial number check result.

20. The method of claim 19, further comprising the step of, according to the check result, unlocking the memory storage card by the verification code of the first security message.

21. The method of claim 18, wherein the memory storage card is unlocked, the first security message comprises a verification code and a serial number set, the second security message comprises a serial number, and the check step comprises the step of checking whether the serial number set comprises the serial number of the second security message to generate the check result.

22. The method of claim 21, further comprising the step of, according to the check result, locking the memory storage card by the verification code of the first security message.

23. The method of claim 18, further comprising the step of changing the first security message.

24. A process apparatus for processing a manager card applied in the management apparatus of claim 1, comprising:
a storage unit being configured to pre-store a first security message; and
a access unit being configured to read the first security message from the storage unit and write the first security message into the manager card.

25. A memory storage card, being applied in the management apparatus as claimed in claim 1, the memory storage card comprising:
a storage unit being configured to store the second security message; and
a transmission interface being configured to provide a transmission path to the management apparatus for accessing the second security message;
wherein the first security message comprises a verification code and a serial number corresponding mutually.
